(19) United States
(12) Patent Application Publication
(10) Pub. No.: US 2025/0021699 A1
(43) Pub. Date: Jan. 16, 2025

(54) CLOUD GOVERNANCE ASSESSMENT ENGINE LEVERAGING ARTIFICIAL INTELLIGENCE (AI)

(71) Applicant: Bank of America Corporation, Charlotte, NC (US)

(72) Inventors: Pratap Dande, Saint Johns, FL (US); Elvis Nyamwange, Little Elm, TX (US); Brian Jacobson, Los Angeles, CA (US); Amer Ali, Jersey City, NJ (US); Erik Dahl, Newark, DE (US); Rahul Phadnis, Charlotte, NC (US); Rahul Yaksh, Austin, TX (US); Hari Vuppala, Charlotte, NC (US); Sailesh Vezzu, Hillsborough, NJ (US)

(21) Appl. No.: 18/221,469

(22) Filed: Jul. 13, 2023

(51) Int. Cl. G06F 21/64; G06N 20/00

(52) U.S. Cl. CPC G06F 21/64; G06N 20/00

(57) ABSTRACT

A cloud governance assessment engine using artificial intelligence (AI) may assess privacy, regulatory, and security concerns before migrating an organization's information technology (IT) services from an on-premises data center to a proposed cloud infrastructure. The assessment may consider whether the proposed cloud infrastructure is able to maintain the governance rules currently implemented at the on-premises data center. The cloud assessment engine may train and use a cloud governance assessment model to analyze, using AI, properties of the proposed cloud infrastructure to determine governance risks. Scoring may be automatically generated by the cloud governance assessment engine based on the risks to evaluate whether the cloud infrastructure meets the requirements of the organization or whether changes to the cloud infrastructure are warranted. The cloud governance assessment engine may make a recommendation for acceptance of a proposed cloud infrastructure or may propose changes to the cloud infrastructure to meet cloud governance requirements.

### FIELD OF THE DISCLOSURE

Aspects of the disclosure relate to technology for leveraging artificial intelligence (AI) to verify that data and related governance controls for computer services may be securely migrated from an on-premises data center to cloud infrastructure.

### BACKGROUND OF THE DISCLOSURE

Many organizations have already migrated some of their computer operations from an on-premises data center (“on prem”) at an organization to cloud computing infrastructure. Cloud infrastructure may simplify computer operations for the organizations as information technology (IT) infrastructure may be located off-site and may be managed by an outside vendor. Some organizations remain reluctant to migrate their computer operations to the cloud due to privacy, regulatory, and security concerns, including a possibility of data being compromised.

### SUMMARY OF THE DISCLOSURE

It is an object of this invention to provide cloud engine governance that may leverage artificial intelligence (AI), including machine learning (ML), to verify whether a particular cloud infrastructure meets an organization's privacy, regulatory, security and other compliance requirements. The cloud governance assessment engine may be used independently or to supplement a human analysis of the cloud infrastructure.

An AI cloud governance assessment computer program product may be provided in accordance with the present disclosure. The computer program product may include executable instructions that, when executed by a processor on a computer system, obtain data from an on-premises data center, where the data is maintained according to one or more of data governance rules implemented at the on-premises data center. The executable instructions may obtain a set of parameters for a cloud infrastructure having a configuration. The executable instructions may train a cloud governance assessment model using a machine learning (ML) algorithm based on the data obtained from the on-premises data center that reflects the data governance rules maintained at the on-premises data center. The cloud governance assessment model may be used to assess, using the cloud governance assessment model and the set of parameters for a cloud infrastructure, risks in migrating the data from the on-premises data center to the cloud infrastructure. The assessment may include an assessment of whether the data governance rules are maintainable at the cloud infrastructure. The assessment may include an assessment of the extent to which the data governance rules are maintainable at the cloud infrastructure. The executable instructions may output an AI-generated risk governance analysis based on the assessed risks in migrating the data.

The data governance rules may include one or more of privacy, regulatory, or security-related rules. The set of parameters of the cloud infrastructure may include one or more of performance specifications, cloud architecture, security measures, costs, or a data framework. The data that is obtained from the on-premises data center may include test data obtained from the on-premises data center.

The assessing of the risks may include assessing whether the risks are at, above, or below a threshold. The threshold may be specified by the organization or another entity. The threshold may be specified by a regulatory agency.

The outputting of the AI-generated risk governance analysis assessment of the risks may include generating an automated score based on the assessed risks. The score may be referred to as a risk analysis score.

The executable instructions may generate a recommendation that recommends whether to migrate the data from the on-premises data center to the cloud infrastructure.

The executable instructions may generate a recommendation for one or more changes to the configuration of the cloud infrastructure to improve risk mitigation at the cloud infrastructure. The one or more changes may include changes to one or more of performance specifications, cloud architecture, security measures, costs, or a data framework.

The executable instructions may reassess, based on the cloud governance assessment model and a revised set of parameters for a cloud infrastructure, risks in migrating the data from the on-premises data center to the cloud infrastructure.

An organization that operates the on-premises data center may be any entity that maintains an on-premises data center.

The executable instructions may further encrypt at least a portion of the data obtained from the on-premises data center, transmit the encrypted data to the cloud infrastructure; and verify whether the encrypted data on the cloud infrastructure remains encrypted.

A method for performing cloud governance analysis using artificial intelligence (AI) may be provided in accordance with the present disclosure. The method may include obtaining data from an on-premises data center, where the data is maintained according to one or more of data governance rules implemented at the on-premises data center. The method may include obtaining a set of parameters for a cloud infrastructure having a configuration. The method may include training a cloud governance assessment model using a machine learning algorithm based on the data obtained from the on-premises data center. The data obtained from the on-premises data center may reflect the data governance rules maintained at the on-premises data center. The cloud governance assessment model and the set of parameters for the cloud infrastructure may be used to assess risks in migrating the data from the on-premises data center to the cloud infrastructure. The assessment may include whether the data governance rules are maintainable at the cloud infrastructure. The assessment may include to what extent the data governance rules are maintainable at the cloud infrastructure. The method may include outputting an AI-generated risk governance analysis based on the assessed risks in migrating the data.

The data governance rules may include one or more of privacy, regulatory, or security-based rules. The set of parameters of the cloud infrastructure include one or more of performance specifications, cloud architecture, security measures, costs, or a data framework. The data that is obtained from the on-premises data center may include test data obtained from the on-premises data center.

The assessing of the risks may include assessing whether the risks are at, below, or above a threshold. The outputting of the AI-generated risk governance analysis assessment of the risks may include generating an automated score based on the assessed risks. The generating of a recommendation may recommend whether to migrate the data from the on-premises data center to the cloud infrastructure.

The generating of a recommendation for one or more changes to the configuration of the cloud infrastructure to mitigate risk before migrating the data from the on-premises data center to the cloud infrastructure. The one or more changes to the configuration may include changes to one or more of performance specifications, cloud architecture, security measures, costs, or a data framework.

A system for artificial intelligence cloud governance assessment of migrating data from an on-premises data center to a cloud infrastructure may be provided in accordance with the present disclosure. The system may include a central server. The central server may include a server communication link, a server processor, and a server non-transitory memory that may be configured to store at least a server operating system and an AI cloud governance assessment engine. The AI cloud governance assessment engine may be configured to train a cloud governance assessment model, using a machine learning algorithm, based on the data obtained from the on-premises data center, wherein the obtained data reflects the data governance rules maintained at the on-premises data center. The AI cloud governance assessment engine may be configured to assess, using the cloud governance assessment model and the set of parameters for a cloud infrastructure, risks in migrating the data from the on-premises data center to the cloud infrastructure. The assessment may include assessing whether the data governance rules are maintainable at the cloud infrastructure. The assessment may include assessing the extent to which the data governance rules are maintainable at the cloud infrastructure. The AI cloud governance assessment engine may be configured to output an AI-generated risk governance analysis based on the assessed risks in migrating the data.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system architecture in accordance with principles of the disclosure.

FIG. 2 shows an illustrative apparatus of a device in accordance with principles of the disclosure.

FIG. 3 shows an illustrative system for cloud governance assessment leveraging AI in accordance with principles of the disclosure.

FIG. 4 shows an illustrative example of a flow chart for performing a method for cloud governance assessment in accordance with principles of the disclosure.

FIG. 5 shows an illustrative system in accordance with principles of the disclosure.

### DETAILED DESCRIPTION OF THE DISCLOSURE

The present disclosure relates to computer program products, methods, and a system for cloud governance assessment analysis that uses artificial intelligence (AI) in evaluating privacy, regulatory, and security concerns over migrating computer operations by an organization from an on-premises data center to a proposed cloud infrastructure. The concerns may be evaluated in comparison to a current risk, cost, and governance oversight by the organization at an on-premises data center. One or more scores may be automatically generated by the cloud governance assessment engine based on the evaluated risks. The scores may be displayed as a scorecard. When one or more of the scores meet or exceed a specified threshold, the risks may have been evaluated to be low. A low risk measurement may provide reassurance to a governance group at an organization that the migration to the cloud may proceed. If one or more of the scores are below a threshold, this may indicate that the risks may not meet the organization's needs. In other embodiments, the scores may be defined differently so that, for example, a score below the threshold indicates a low risk and a score above the threshold indicates a higher risk.

Illustrative embodiments of methods, systems, and apparatus in accordance with the principles of the invention will now be described with reference to the accompanying drawings, which form a part hereof. It is to be understood that other embodiments may be used, and structural, functional, and procedural modifications may be made without departing from the scope and spirit of the present invention.

The drawings show illustrative features of methods, systems, and apparatus in accordance with the principles of the invention. The features are illustrated in the context of selected embodiments. It will be understood that features shown in connection with one of the embodiments may be practiced in accordance with the principles of the invention along with features shown in connection with another of the embodiments.

The methods, apparatus, computer program products, and systems described herein are illustrative and may involve some or all the steps of the illustrative methods and/or some or all of the features of the illustrative system or apparatus. The steps of the methods may be performed in an order different than the order shown or described herein. Some embodiments may omit steps shown or described in connection with the illustrative methods. Some embodiments may include steps that are not shown or described in connection with the illustrative methods, but rather are shown or described in a different portion of the specification.

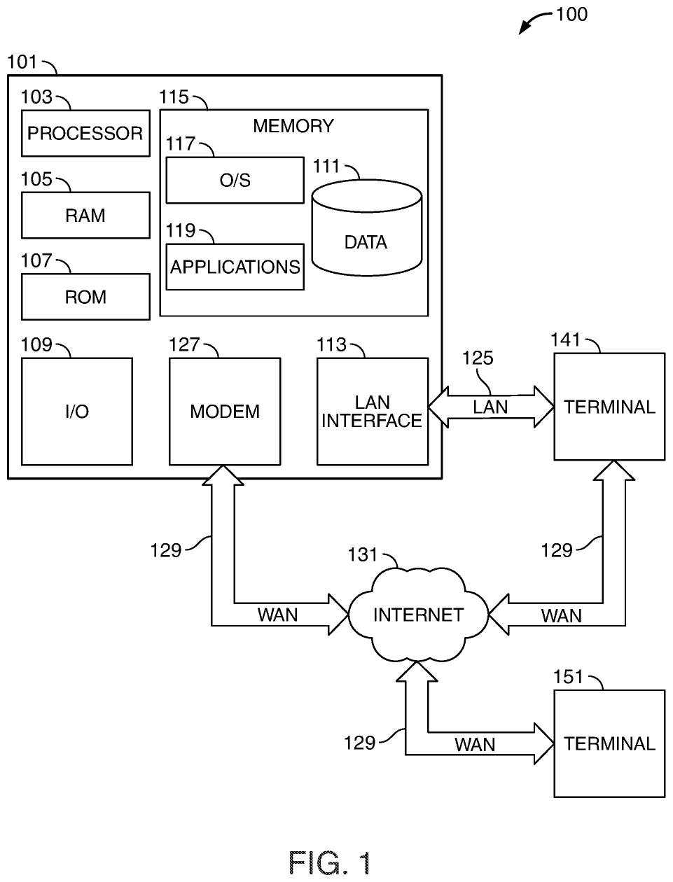

FIG. 1 shows an illustrative block diagram of system 100 that includes computer 101. Computer 101 may alternatively be referred to herein as an “engine,” “server” or a “computing device.” Computer 101 may be any computing device described herein, such as the computing devices running on a computer, smart phones, smart cars, smart cards, and any other mobile device described herein. Elements of system 100, including computer 101, may be used to implement various aspects of the systems and methods disclosed herein.

Computer 101 may have a processor 103 for controlling the operation of the device and its associated components, and may include RAM 105, ROM 107, input/output circuit 109, and a non-transitory or non-volatile memory 115. Machine-readable memory may be configured to store information in machine-readable data structures. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of computer 101. Memory 115 may also store videos, text, and/or audio assistance files. The data stored in Memory 115 may also be stored in cache memory, or any other suitable memory.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all the elements described above relative to computer 101.

In some embodiments, computer 101 and/or Terminals 141 and 151 may be any of mobile devices that may be in electronic communication with consumer device 106 via LAN, WAN, or any other suitable short-range communication when a network connection may not be established.

When used in a LAN networking environment, computer 101 is connected to LAN 125 through a LAN interface 113 or an adapter. When used in a WAN networking environment, computer 101 may include a communications device, such as modem 127 or other means, for establishing communications over WAN 129, such as Internet 131.

In some embodiments, computer 101 may be connected to one or more other systems via a short-range communication network (not shown). In these embodiments, computer 101 may communicate with one or more other terminals 141 and 151, such as the mobile devices described herein etc., using a personal area network (PAN) such as Bluetooth®, NFC (Near Field Communication), ZigBee, or any other suitable personal area network.

It will be appreciated that the network connections shown are illustrative and other means of establishing a communications link between computers may be used. The existence of various well-known protocols such as TCP/IP, Ethernet, NFT, HTTP, and the like is presumed, and the system can be operated in a client-server configuration to permit retrieval of data from a web-based server or API (Application Programming Interface). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may use one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may use the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry™, tablet, smartphone, or any other computing system for receiving, storing, transmitting and/or displaying relevant information. Terminal 151 and/or terminal 141 may be one or more user devices. Terminals 151 and 141 may be identical to computer 101 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smartphones, multiprocessor systems, microprocessor-based systems, cloud-based systems, programmable consumer electronics, network PCs, minicomputers, mainframe computers, distributed computing environments that include any of the above systems or devices, and the like.

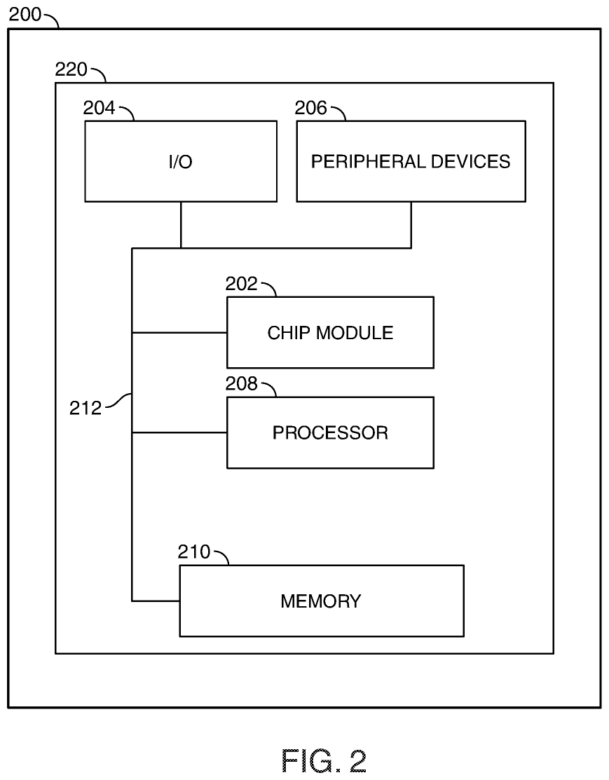

FIG. 2 shows illustrative apparatus 200, which may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

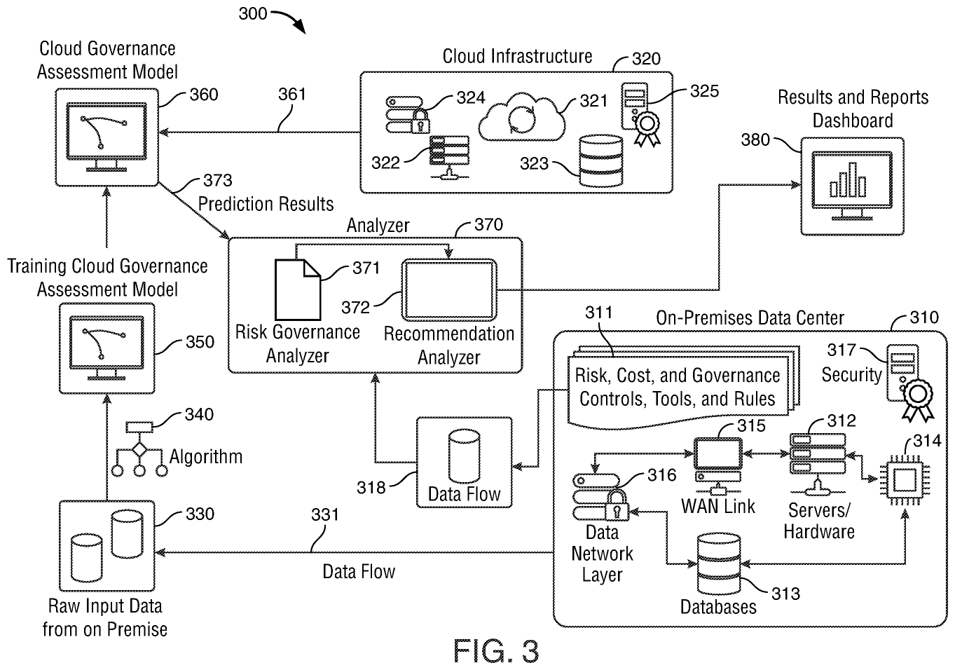

FIG. 3 shows an illustrative system 300 in accordance with the present disclosure. On-premises data center 310 may be implemented at an organization's facility. On-premises data center 310 may include a data framework, including risk, cost, and governance controls, tools, and rules engine 311 that may be configured to operate on-premises data center 310. On-premises data center 310 may include one or more servers and hardware 312. On-premises data center 310 may include one or more databases 313. On-premises data center 310 may include non-transitory memory. On-premises data center 310 may include one or more processors 314. On-premises data center 310 may include a wide area network (WAN) link 315. On-premises data center 310 may include a data network layer 316 which may include a firewall. On-premises data center 310 may include other security hardware and applications 317.

The organization may be an organization that has one or more on-premises data centers on which data governance policies and procedures are implemented. The policies and procedures may include rules regarding privacy, regulatory, or security requirements, such as may be included in an organization's data framework. The organization may be, for example, a financial or insurance organization, or another entity that operates an on-premises data center.

A cloud infrastructure 320 may be considered for use by the organization to offload at least some IT functions from the on-premises data center to the cloud. Cloud infrastructure may be operated by a vendor. Cloud infrastructure 320 may provide a cloud 321 on which applications and data may be stored. Cloud may include servers/hardware 322, databases 313, a data network layer 324, and security applications 325. Cloud infrastructure 320 may be a private cloud dedicated to a single organization or may be shared among multiple organizations simultaneously. Factors to be considered in migrating to a cloud may include privacy, regulatory, and security protections. Other factors that may be considered include quality of service to be guaranteed and speed. The vendor managing the cloud may offer various levels of services and features. An organization may select services and features to be considered in evaluating the cloud infrastructure 320. The selected services and feature may affect the risks of migrating to cloud infrastructure 320.

Data from on-premises data center 310 may be transmitted over link 331 and obtained as raw input data to be stored in a memory at 330. Data that is transmitted over link 331 may include the organization's data stored at on-premises data center 310. The data transmitted over link 331 may include data regarding a data governance framework including risk, cost, and governance control, tools, and rules implemented at on-premises data center 310.

The raw input data that is obtained at 330 may be processed by an algorithm 340 that uses machine learning to extract data to be used in training a cloud governance assessment model 350. Algorithm 340 may use a neural network. Training data may be used at 350 to train a cloud governance assessment model to identify the significant features in the data framework as implemented on on-premises data center 310. Once trained, cloud governance assessment model 360 may be used to perform a cloud governance assessment of the proposed cloud infrastructure 320 that the organization is considering as a partial or complete replacement of on-premises data center 310. Cloud infrastructure 320 may feed parameters of the cloud infrastructure 320 for assessment by cloud governance assessment model 360 over link 361 to be used for evaluation of the cloud infrastructure based on the cloud governance assessment model in generating an assessment of migrating the organization's data to the proposed cloud infrastructure.

In embodiments, at least a portion of the data obtained from the on-premises data center may be encrypted and the cloud infrastructure further tested by transmitting the encrypted data to the cloud infrastructure, and verifying whether the encrypted data on the cloud infrastructure remains encrypted.

Prediction results 373, based on a cloud governance assessment performed using cloud governance assessment model 360, may be provided to an analyzer 370. In embodiments, risk, cost, and governance data may be provided from risk, cost, and governance controls, tools, and rules engine directly to analyzer 370 as a data flow 318 transmitted from on-premises data center 310.

Analyzer 370 may include a risk governance analyzer 371 that analyzes whether and how closely the proposed cloud infrastructure complies with the organization's risk governance policies. Risks that may be analyzed by risk governance analyzer 371 may include, for example, determining whether the cloud infrastructure has resources to handle the data, whether there are capabilities for implementing access restrictions and controls, including privacy and regulatory requirements and security protections including firewall and other security protections.

Risk governance analyzer 371 may be configured, such as in hardware or software, to automatically generate one or more risk analysis scores. The scores may be displayed on a scorecard. In embodiments, the score may provide one overall number that reflects an overall governance score or rating as to how the cloud infrastructure meets the desired protection. For example, the score may be a value, such as a percentage from 0% to 100% or a number on a scale of 1 to 10, that reflects how closely the protection offered by a current proposed configuration of the cloud infrastructure 320 meets criteria specified in the cloud governance assessment model. In embodiments, the score may provide multiple values for different categories of risks that may be considered. For example, separate scores may be provided for privacy risks, regulatory risks, and security risks. The risk analysis may include comparing one or more of the scores to risk values specified by the organization. The scoring may be used to recommend whether the cloud infrastructure should be considered acceptable to the organization or to recommend possible enhancements to the cloud.

Analyzer 370 may further include a recommendation analyzer 372 to analyze the predicted results and provide a recommendation. Recommendation analyzer 372 may be configured, such as in hardware or software, to provide recommendations as to how proceed. The recommendations may be provided to a decision maker.

The recommendation may recommend whether to proceed with the migration to the cloud infrastructure 320 based on proposed parameters or may recommend what changes to the cloud infrastructure parameters may be considered to enhance cloud protections or to meet governance policies and procedures of the organization. As an example of recommendations, the cloud governance assessment may use the cloud governance assessment model to determine parameters or a combination of parameters that are or are not met by the cloud infrastructure 320. Recommendation analyzer 372 may be configured to prepare a proposal to change the cloud infrastructure to reduce risk of migrating to the cloud infrastructure. Recommendations may include what aspects (e.g., hardware, capacity, speed, administration) of the cloud infrastructure 320 may be changed. Recommendations may include, for example, adding additional resources at the cloud infrastructure devoted to the organization, adding more controls for risk governance, improving isolation of the organization's data, and adding security software with improved capabilities.

If changes to cloud infrastructure 320 from the initial configuration to a different configuration are under consideration by the organization, these changes may be reprocessed through cloud governance assessment model 360 to reassess whether the changes improve the score. If changes are not feasible with one cloud vendor, another vendor may be consulted and a proposal from the second cloud vendor may be analyzed using the cloud governance assessment model 360.

Outputs from risk governance analyzer 371 and recommendation analyzer 372, including a score and recommendations, may be presented on a results and reports dashboard 380. The score may be displayed as a score on a scorecard.

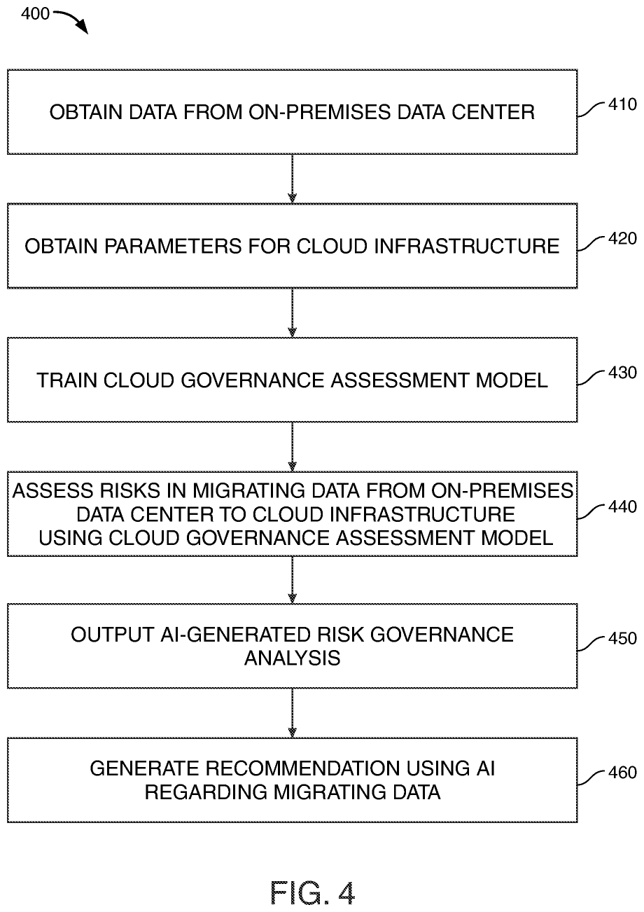

FIG. 4 shows an illustrative example of a flow chart 400 for performing a cloud data governance analysis using artificial intelligence in accordance with the present disclosure. At step 410, data may be obtained from an on-premises data center. At step 420, parameters of a cloud infrastructure having a configuration may be obtained. The parameters of the cloud infrastructure may include one or more of performance standards, architecture, security measures, risk assessment, costs, or a data framework that may be provided, such as to protect privacy and policy compliance. At step 430, a cloud governance assessment model may be trained using a machine learning algorithm and data obtained from the on-premises data center to be able to assess risks associated with migrating data of the organization from the on-premises data center to the cloud infrastructure having the configuration. In embodiments, step 420 may be alternatively performed before step 410 or after step 430.

At step 440, the cloud governance assessment model that has been trained may be used to assess the privacy, regulatory, and security risks of migrating the data to the configuration of the cloud infrastructure.

At step 450, an AI-generated risk governance analysis may be generated and output for use by the organization. One or more scores may be generated. The one or more scores may indicate whether the cloud infrastructure meets the risk governance framework implemented at the on-premises data center.

At step 460, one or more AI-generated recommendations may be generated and provided to the organization, based on the assessed privacy, regulatory, and security risks. The recommendations may relate to whether to accept or decline the migration of the data from the on-premises data center to the configuration of the cloud infrastructure. The recommendations may relate to whether to make changes to the cloud infrastructure.

Should the organization change the configuration that is proposed to be used for the cloud infrastructure in response to the one or more recommendations, such as to change the cloud to a second infrastructure, the privacy, regulatory and security risks of the revised cloud infrastructure may be reassessed using the cloud governance assessment model and a risk and recommendation analyses may be generated.

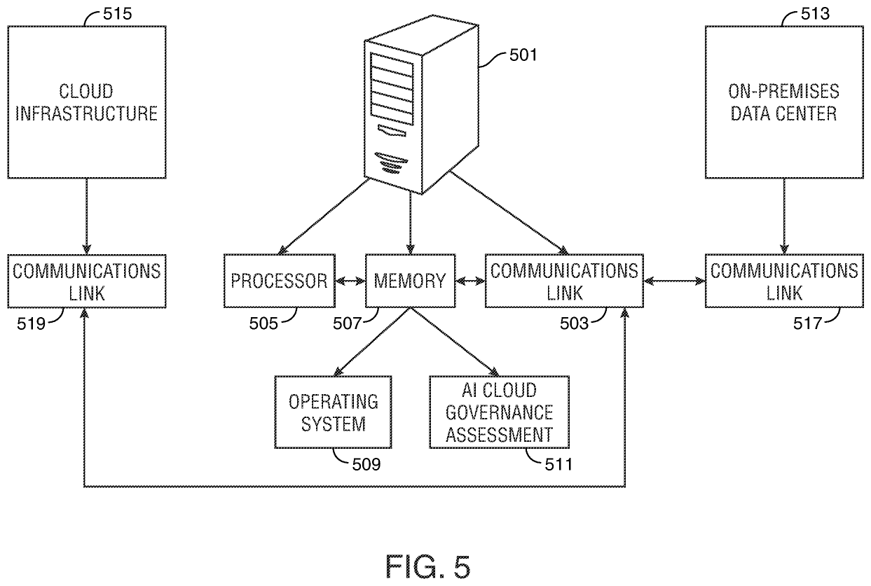

FIG. 5 shows an illustrative system in accordance with principles of the disclosure. The system may include a central server 501 and an on-premises data center 513 that may interface with a cloud infrastructure 515.

Central server 501 may include a server communications link 503, a server processor/processors 505, and a server non-transitory memory 507, as well as other components.

On-premises data center 513 may include one or more of the elements in on-premises data center 310 described above. Cloud infrastructure 515 may include one or more of the elements in cloud infrastructure 320 described above.

The server non-transitory memory 507 may include a server operating system 509, an AI Cloud Governance Assessment Engine 511, as well as other data and programs. AI Cloud Governance Assessment Engine 511 may be programmed to include one or more of:
obtaining data from an on-premises data center. The data may be maintained according to the one or more data governance rules implemented at the on-premises data center.
obtaining a set of parameters for a cloud infrastructure having a configuration.
training a cloud governance assessment model, using a machine learning algorithm, based on the data obtained from the on-premises data center that reflects the data governance rules maintained at the on-premises data center.
assessing, using the cloud governance assessment model and the set of parameters for a cloud infrastructure, risks in migrating the data from the on-premises data center to the cloud infrastructure.
outputting an AI-generated risk governance analysis based on the assessed risks in migrating the data.

The server communications link 503 may communicate with on-premises data center 513 and cloud infrastructure 515 (as well as other servers/computers, not shown) through node communications link 517. The AI Cloud Governance Assessment Engine 511 may communicate with on-premises data center 513 and cloud infrastructure 515 through the server communications link 503.

By leveraging an artificial intelligence model to determine whether a particular cloud infrastructure meets the computing needs of an organization, including the privacy, regulatory, and security needs, the migration of an organization's computing platform to the cloud may be more pursued with greater confidence by decision makers at the organization. The migration may therefore be pursued more expeditiously.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods, systems, and computer program products may implement an AI-based cloud assessment of data governance at a cloud infrastructure to consider a migration of an on-premises data center to a cloud infrastructure. Persons skilled in the art will appreciate that the present invention can be practiced by other than the described embodiments, which are presented for purposes of illustration rather than of limitation.

What is claimed is:

1. An artificial intelligence (AI) cloud governance assessment computer program product comprising executable instructions that, when executed by a processor on a computer system:
obtain data from an on-premises data center, wherein the data is maintained according to one or more data governance rules implemented at the on-premises data center;
obtain a set of parameters for a cloud infrastructure having a configuration;
train a cloud governance assessment model, using a machine learning algorithm, based on the data obtained from the on-premises data center, wherein the data reflects the data governance rules maintained at the on-premises data center;
assess, using the cloud governance assessment model and the set of parameters for a cloud infrastructure, risks in migrating the data from the on-premises data center to the cloud infrastructure; and
output an AI-generated risk governance analysis based on the assessed risks in migrating the data.

2. The computer program product of claim 1, wherein the one or more data governance rules include one or more rules relating to privacy, laws or regulations, or security.

3. The computer program product of claim 1, wherein the set of parameters of the cloud infrastructure include one or more of performance specifications, cloud architecture, security measures, costs, or a data framework.

4. The computer program product of claim 1, wherein the data that is obtained from the on-premises data center comprises test data obtained from the on-premises data center.

5. The computer program product of claim 1, wherein the assessing of the risks comprises assessing whether the risks are at, below, or above a user-specified threshold.

6. The computer program product of claim 1, wherein the output of the AI-generated risk governance analysis of the risks comprises generating an automated score based on the assessed risks.

7. The computer program product of claim 1, wherein the executable instructions further generate a recommendation that recommends whether to migrate the data from the on-premises data center to the cloud infrastructure.

8. The computer program product of claim 1, wherein the executable instructions further generate a recommendation for one or more changes to the configuration of the cloud infrastructure to reduce risk at the cloud infrastructure.

9. The computer program product of claim 8, wherein the one or more changes include one or more changes to performance specifications, cloud architecture, security measures, costs, or a data framework of the cloud infrastructure.

10. The computer program product of claim 1, wherein the executable instructions reassess, based on the cloud governance assessment model and a revised configuration for a cloud infrastructure, risks in migrating the data from the on-premises data center to the cloud infrastructure.

11. The computer program product of claim 1, wherein the executable instructions further:
encrypt a portion of the data obtained from the on-premises data center;
transmit the encrypted portion of the data to the cloud infrastructure; and
verify whether the encrypted portion of the data on the cloud infrastructure remains encrypted.

12. A method for performing cloud governance assessment analysis using artificial intelligence (AI), comprising:
obtaining data from an on-premises data center, wherein the data comprises is maintained according to one or more of data governance rules implemented at the on-premises data center;
obtaining a set of parameters for a cloud infrastructure having a configuration;
training a cloud governance assessment model, using a machine learning algorithm, based on the data obtained from the on-premises data center, wherein the obtained data reflects the data governance rules maintained at the on-premises data center;
assessing, using the cloud governance assessment model and the set of parameters for a cloud infrastructure, risks in migrating the data from the on-premises data center to the cloud infrastructure; and
outputting an AI-generated risk governance analysis based on the assessed risks in migrating the data.

13. The method of claim 12, wherein the data governance rules include one or more of privacy, regulatory, or security-based rules.

14. The method of claim 12, wherein the set of parameters of the cloud infrastructure include one or more of performance specifications, cloud architecture, security measures, costs, or a data framework.

15. The method of claim 12, wherein the assessing of the risks comprises assessing whether the risks are at, below, or above a user-specified threshold.

16. The method of claim 12, wherein the outputting of the AI-generated risk governance analysis assessment of the risks comprises generating an automated score based on the assessed risks.

17. The method of claim 12, further comprising generating a recommendation that recommends whether to migrate the data from the on-premises data center to the cloud infrastructure.

18. The method of claim 12, further comprising generating a recommendation for one or more changes to the configuration of the cloud infrastructure to mitigate risk before migrating the data from the on-premises data center to the cloud infrastructure, wherein the one or more changes include changes to one or more of performance specifications, cloud architecture, security measures, costs, or a data framework.

19. The method of claim 12, wherein the executable instructions reassess, based on the cloud governance assessment model and a revised configuration for a cloud infrastructure, risks in migrating the data from the on-premises data center to the cloud infrastructure.

20. A system for artificial intelligence (AI) cloud governance assessment of migrating data from an on-premises data center to a cloud infrastructure, the system comprising:
a central server, the central server including:
a server communication link;
a server processor; and
a server non-transitory memory configured to store at least:
a server operating system; and
an AI cloud governance assessment engine;
wherein the AI cloud governance assessment engine:
trains a cloud governance assessment model, using a machine learning algorithm, based on the data obtained from the on-premises data center, wherein the obtained data reflects data governance rules maintained at the on-premises data center;
assesses, using the cloud governance assessment model and a set of parameters for a cloud infrastructure, risks in migrating the data from the on-premises data center to the cloud infrastructure; and
outputs an AI-generated risk governance analysis based on the assessed risks in migrating the data.
